(19) United States
(12) Patent Application Publication
(10) Pub. No.: US 2025/0179321 A1
(43) Pub. Date: Jun. 5, 2025

(54) WATERBORNE EMULSION FOR WOOD SUBSTRATE AND METHOD FOR PREPARING THE SAME, COATING COMPOSITION AND ARTICLE

(71) Applicant: GUANGDONG HUARUN PAINTS CO., LTD., Foshan City (CN)

(72) Inventor: Weiqi Zhang, Foshan City (CN)

(21) Appl. No.: 18/844,077

(22) PCT Filed: Apr. 13, 2023
(86) PCT No.: PCT/CN2023/088048

§ 371 Date: Sep. 5, 2024

(30) Foreign Application Priority Data
Apr. 13, 2022 (CN) 202210383683.8

(51) Int. Cl. C09D 15/00; C09D 5/02; C09D 133/14

(52) U.S. Cl. CPC C09D 15/00; C09D 5/022; C09D 133/14

(57) ABSTRACT

Aqueous emulsion used for woodware, comprises polymer particles with core-shell structure, where core of polymer particles is obtained by copolymerizing monomer mixture I, and shell of polymer particles is obtained by copolymerizing monomer mixture II, and the polymer particles having core-shell structure have a hydroxyl content of from 0.2% to 2.2% by weight. The aqueous emulsion for woodware can produce a coating having excellent chemical resistance while maintaining a satisfactory drying rate.

### CROSS REFERENCE TO RELATED APPLICATION

This application is an international patent application which claims priority to Chinese Patent Application No. 202210383683.8, filed on Apr. 13, 2022, the entire contents of which is incorporated herein by reference.

### TECHNICAL FIELD

The application relates to a waterborne emulsion for wood substrate, a method for preparing the same, and a coating composition containing the waterborne emulsion for wood substrate. The application also relates to an article comprising the waterborne emulsion for wood substrate or the coating composition.

### BACKGROUND

In recent years, with people's increasing concern about the environment, many countries have enacted environmental laws to require a further reduction in the amount of VOCs that are allowed to be released into the air from coating compositions (especially solvent-based coating compositions).

Waterborne acrylic coatings are more and more accepted by consumers in the field of wood substrate, because of their advantages of low VOC, environmental friendliness, good film-forming properties, gloss and color retention, and good application performance. However, one-component acrylic resin for forming a film is not crosslinked, resulting in poor compactness of coating film, poor hot water resistance and alcohol resistance.

In order to improve the chemical resistance of acrylic resins, one way is to introduce hydroxyl functional monomers and increase the amount of curing agents to obtain coatings with high hydroxyl value and high crosslinking density. The hydroxyl value is determined using ASTM E222-65T. The hydroxyl equivalent weight (OH EW) is calculated by 56100 being divided by the hydroxyl value:

Equivalent weight (g/equivalent)=56100/Hydroxyl value

However, such acrylic resin coatings with high hydroxyl value result in a slow drying step and a substantially increased overall cost of the coating. Another way is to add an additional crosslinking system, such as silicone resin, ketone-hydrazine crosslinking system, to provide an additional crosslinked structure, thereby increasing the crosslinking density. However, the improvement of these additional crosslinking systems on crosslinking density is very limited, so that the alcohol resistance and hot water resistance of the coating are still unsatisfactory. Moreover, when the addition amount of the additional crosslinking system is too high, it may also lead to problems such as increased cost, reduced system stability, and poor application performance.

### SUMMARY

In view of the above, there is a need for a low-OH (hydroxyl value) waterborne emulsion for wood substrate that can provide excellent chemical resistance while maintaining satisfactory drying speed and low cost.

These goals can be achieved by the waterborne emulsion for wood substrate as described herein.

In the first aspect of the present application, a waterborne emulsion for wood substrate comprising polymer particles having core-shell structure is provided, characterized in that the core in the polymer particles is obtained by copolymerization of monomer mixture I, and the shell in the polymer particles is obtained by copolymerization of monomer mixture II, wherein the monomer mixture I and the monomer mixture II each independently contain at least one acrylic monomer with at least one hydroxyl group and at least one functional monomer with two or more double bonds, and weight ratio of the at least one acrylic monomer with at least one hydroxyl group in the monomer mixture I to the at least one acrylic monomer with at least one hydroxyl group in the monomer mixture II is in a range of from 1:30 to 2:1, and the polymer particles having core-shell structure have a hydroxyl content of from 0.2% to 2.2% by weight.

In the second aspect of the present application, a method for preparation of a waterborne emulsion for wood substrate is provided, including
1) pre-emulsification step to obtain a pre-emulsion I and a pre-emulsion II,
wherein the pre-emulsion I is prepared by mixing at least one emulsifier with water, and then adding monomer mixture I; and
wherein the pre-emulsion II is prepared by mixing at least one emulsifier with water, and then adding monomer mixture II; and
2) polymerization by: i) mixing the pre-emulsion I and at least one initiator to carry out polymerization reaction; and ii) adding the pre-emulsion II to the pre-emulsion I and at least one initiator to carry out polymerization reaction;
wherein the monomer mixture I and the monomer mixture II each independently contain at least one acrylic monomer with at least one hydroxyl group and at least one functional monomer with two or more double bonds. and weight ratio of the at least one acrylic monomer with at least one hydroxyl group in the monomer mixture I to the at least one acrylic monomer with at least one hydroxyl group in the monomer mixture II is in a range of from 1:30 to 2:1, and the waterborne emulsion for wood substrate comprises polymer particles having core-shell structure and having a hydroxyl content of from 0.2% to 2.2% by weight.

In the third aspect of the present application, a waterborne coating composition is provided, characterized in that the coating composition comprising: a) the waterborne emulsion for wood substrate, and b) at least one curing agent.

In a fourth aspect of the present application, an article is provided, comprising: a wood substrate having at least one major surface; and the waterborne emulsion for wood substrate as described herein applied on the at least one major surface of the wood substrate.

The inventors have surprisingly found that by adjusting the relative amounts of hydroxyl monomers in the core and shell of the polymer particles while maintaining the polymer particles with a low hydroxyl content within a specific range, the waterborne emulsion for wood substrate in the present application not only has low cost, but also can produce a coating with excellent chemical resistance. Especially in terms of alcohol resistance and water resistance, the waterborne emulsion for wood substrate in the present application shows a significant improvement of performance, compared with commercially available emulsions.

In addition, the waterborne emulsion for wood substrate in the present application can further increase the drying speed, and improve the application performance while maintaining excellent alcohol resistance.

The waterborne emulsion for wood substrate in the present application can provide excellent comprehensive performance in terms of drying speed, water resistance, alcohol resistance, hot water resistance and the like.

The above summary of the present application is not intended to describe each disclosed embodiment or every implementation in this application. Illustrative embodiments are exemplified in more detail in the description that follows.

### DETAILED DESCRIPTION

### Selected Definitions

As used herein, “a”, “an”, “the”, “at least one”, and “one or more” are used interchangeably. Thus, for example, a coating composition that comprises “an” additive can be interpreted to mean that the coating composition includes “one or more” additives. As used herein, the singular forms are intended to include the plural forms as well, unless the context clearly indicates otherwise.

Unless otherwise indicated, the terms “comprises”, “having”, “including”, “incorporating”, and variations thereof do not have a limiting meaning, but rather these terms in the description and claims are intended to be open-ended and non-limiting. For example, where compositions are described as having, including, or comprising specific components or fractions, or where processes are described as having, including, or comprising specific process steps, it is contemplated that the compositions or processes as disclosed herein may further comprise other components or fractions or steps, whether or not, specifically mentioned in this invention, as along as such components or steps do not affect the basic and novel characteristics of the invention, but it is also contemplated that the compositions or processes may consist essentially of, or consist of, the recited components or steps.

For the sake of brevity, only certain ranges are explicitly disclosed herein. However, it should be understood that any lower limit may be combined with any upper limit to recite a range not explicitly recited, as well as, any lower limit may be combined with any other lower limit to recite a range not explicitly recited, in the same way, any upper limit may be combined with any other upper limit to recite a range not explicitly recited. Additionally, although not explicitly recited, every point or individual value within a range is expressly included in the range. Thus, every point or individual value may serve as its own lower or upper limit and be combined with any other point or individual value or any other lower or upper limit, to form a range not explicitly recited.

Unless otherwise indicated, the recitations of numerical ranges by endpoints include all numbers subsumed within that range. For example, a range of from 1 to 5 includes 1, 1.5, 2, 2.75, 3, 3.80, 4, 5, etc. Furthermore, disclosure of a range includes disclosure of all subranges included within the broader range. For example, a range of from 1 to 5 discloses the subranges of from 1 to 4, from 1.5 to 4.5, from 1 to 2, etc. Thus, every point or individual value may serve as a lower or upper limit combined with any other point or individual value or any other lower or upper limit, to recite a range explicitly recited in the present application.

As used herein, “or” refers to an inclusive. That is, the phrase “A or B” means “A, B, or both A and B”, which can also be abbreviated as “A and/or B”. More specifically, a condition A or B is satisfied by any one of the following: A is true (or present) and B is false (or not present); A is false (or not present) and B is true (or present); and both A and B are true (or present). In contrast, the exclusive “or” is represented herein, for example, by terms such as “either A or B” and “one of A or B”.

Unless otherwise specified, the term “emulsion” refers to an emulsified liquid formed by emulsifying in water a liquid polymer or a polymer that is dissolved in an organic solvent into a solution with an emulsifier, and an emulsion usually has a larger average particle size (such as from 0.1 to 1 μm) and opaque appearance.

When used in the context of self-crosslinking polymers, the term “self-crosslinking” means that a polymer is capable of participating in a crosslinking reaction with itself and/or other polymers in the absence of an external crosslinking agent to form a covalent linkage therebetween. Typically, the crosslinking reaction is carried out by the reaction of complementary reactive functional groups present in the self-crosslinking polymer itself or in two separate molecules of the self-crosslinking polymer.

In the context of the present application, the term “monomer mixture” means a mixture of reactive monomers, excluding unreacted solvents.

In the context of the present application, “hydroxyacrylic resin” means a type of resin obtained by polymerization of (meth)acrylate monomers and hydroxyalkyl (meth)acrylate monomers and optionally other ethylenically unsaturated monomers in the presence of an initiator.

Reference to “(meth)acrylate” compounds is meant to include both acrylate and methacrylate compounds, unless otherwise stated.

When used in the context of “a coating applied on a surface or substrate,” the term “on” includes coatings that are applied directly or indirectly on the surface or substrate. Thus, for example, a coating applied on a primer coating on a substrate is regarded as a coating applied on the substrate.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

### Waterborne Emulsion

The waterborne emulsion for wood substrate according to the first aspect of the present application comprises polymer particles having core-shell structure, wherein the core in the polymer particles is obtained by copolymerization of monomer mixture I, and the shell in the polymer particles is obtained by copolymerization of monomer mixture II, wherein the monomer mixture I and the monomer mixture II each independently contain at least one acrylic monomer with at least one hydroxyl group and at least one functional monomer with two or more double bonds, and weight ratio of the at least one acrylic monomer with at least one hydroxyl group in the monomer mixture I to the at least one acrylic monomer with at least one hydroxyl group in the monomer mixture II is in a range of from 1:30 to 2:1, and the polymer particles having core-shell structure have a hydroxyl content of from 0.2% to 2.2% by weight.

According to the application, monomer mixture I and monomer mixture II may comprise crosslinking monomers. In the present application, “crosslinking monomer” is a monomer capable of providing two or more reaction sites capable of forming chemical bonds or hydrogen bonds. The addition of crosslinking monomers may increase the crosslinking effect between polymers and greatly improve the chemical resistance of the coating.

Without wishing to be bound by theory, by using the monomer mixture I and monomer mixture II described herein, at least two types of crosslinking can occur during core-shell emulsion polymerization, namely internal self-crosslinking and external curing crosslinking (referred to as “internal crosslinking” and “external crosslinking”, respectively). During the formation of the core, the acrylic monomer and the functional monomer in the monomer mixture I undergo a polymerization reaction, resulting in a self-crosslinked structure in the core, and also generating reactive functional side chains with double bonds. During the formation of the shell, not only the acrylic monomer and the functional monomer in the monomer mixture II can be polymerized to generate a self-crosslinked structure in the shell, but also can undergo a polymerization reaction with the side chain having an active functional group with a double bond on the surface of the core, resulting in a crosslinked structure between the core and the shell. In addition, both the core and the shell can provide active functional groups with hydroxyl groups when reacting with the curing agent, thereby providing an externally crosslinked structure. Through internal self-crosslinking and external crosslinking, an interpenetrating network structure can be formed in the polymer particles.

Compared with conventional self-crosslinking system, the waterborne emulsion of the present application not only has good internal compatibility of the system, but also produces a crosslinked structure with high stability and higher crosslinking density, which makes the coating film compact and chemical-resistant performance has been greatly improved.

Furthermore, the waterborne emulsion for wood substrate described herein has low hydroxyl content, satisfactory drying speed, and low cost. In some embodiments, the polymer particles having a core-shell structure have a hydroxyl content of from 0.5% to 2.1% by weight. For example, the hydroxyl content of the polymer particles having a core-shell structure is 0.6%, 0.8%, 1.0%, 1.2%, 1.5%, 1.6%, 1.8%, or 2.0% by weight.

In some embodiments, the weight ratio of the monomer mixture I to the monomer mixture II is 1:20-3.5:1, preferably 1:10-2:1. For example, the weight ratio of monomer mixture I to monomer mixture II may be about 1:15, 1:10, 1:8, 1:7, 1:6, 1:5, 1:4, 1:3, 1:2, 1:1, 2:1, or 3:1. The inventors have found that very excellent properties of coating can be obtained by applying a weight ratio within the above range. This is quite unexpected since existing studies seem to recommend higher weight ratios to increase the core/shell weight ratio. Without wishing to be bound by theory, it is believed that the use of internal cross-linking+external cross-linking in both the core layer and the shell layer allows to reduce the relative weight of the core layer while maintaining excellent core-shell stability and an improved crosslinking density.

The alkyl group in the acrylic monomer with at least one hydroxyl group may have 1-15 carbon atoms, for example 1-6 carbon atoms. In some embodiments, the acrylic monomer with at least one hydroxyl group is one or more of hydroxyethyl (meth)acrylate, hydroxypropyl (meth)acrylate, hydroxybutyl (meth)acrylate, hydroxypentyl (meth)acrylate and hydroxyhexyl (meth)acrylate.

In some embodiments, based on the total weight of the monomer mixture I, the at least one acrylic monomer with at least one hydroxyl group in the monomer mixture I is present in an amount of from 1% to 10%. For example, the amount of the at least one acrylic monomer with at least one hydroxyl group in monomer mixture 1 may be about 2%, 3%, 4%, 5%, 6%, 7%, 8% or 9%, based on the total weight of monomer mixture I.

In some embodiments, based on total weight of the monomer mixture II, the at least one acrylic monomer with at least one hydroxyl group in the monomer mixture II is present in an amount of from 10% to 40%. For example, the amount of the at least one acrylic monomer with at least one hydroxyl group in monomer mixture I may be about 12%, 15%, 20%, 25%, 30%, 35% or 38%, based on the total weight of monomer mixture I.

The alkyl group in the functional monomer with at least two or more double bonds (carbon-carbon double bonds) may have 1-15 carbon atoms, for example 1-6 carbon atoms. In some embodiments, the at least one functional monomer with two or more double bonds is one or more of allyl methacrylate, allyl acrylate, ethylene glycol dimethacrylate, ethylene glycol diacrylate, 1,3-butanediol dimethacrylate, 1,3-butanediol diacrylate, 1,4-butanediol dimethacrylate, 1,4-butanediol diacrylate, 1,6-hexanediol dimethacrylate, 1,6-hexanediol diacrylate, diethylene glycol dimethacrylate, diethylene glycol diacrylate, triethylene glycol dimethacrylate, triethylene glycol diacrylate, dipropylene glycol dimethacrylate, dipropylene glycol diacrylate, tripropylene glycol dimethacrylate, tripropylene glycol diacrylate, trimethylolpropane trimethacrylate, trimethylolpropane triacrylate, pentaerythritol trimethacrylate, pentaerythritol triacrylate, pentaerythritol tetramethacrylate, pentaerythritol tetraacrylate and divinylbenzene. In some embodiments, the functional monomer with two or more double bonds is one or more of allyl methacrylate, allyl acrylate, 1,6-hexanediol dimethacrylate, and 1,6-hexanediol diacrylate. More preferably, the functional monomer with two or more double bonds is allyl methacrylate, allyl acrylate or a combination of both.

In some embodiments, based on the total weight of the monomer mixture I, the at least one functional monomer with two or more double bonds in the monomer mixture I is present in an amount of from 0.05% to 5%. For example, the amount of the at least one functional monomer with two or more double bonds in monomer mixture I may be about 0.08%, 0.1%, 0.5%, 1%, 1.5%, 2%, 2.5%, 3%, 3.5%, 4% or 4.5%, based on the total weight of monomer mixture I.

In some embodiments, based on total weight of the monomer mixture II, the at least one functional monomer with two or more double bonds in the monomer mixture II is present in an amount of from 0.5% to 10%. For example, the amount of the at least one functional monomer with two or more double bonds in monomer mixture II may be about 0.6%, 0.8%, 1%, 1.2%, 1.4%, 1.5%, 1.8%, 2%, 2.5%, 3%, 3.5%, 4% or 4.5%, based on the total weight of monomer mixture II.

In addition to the acrylic monomers with at least one hydroxyl group and the functional monomers with two or more double bonds, the monomer mixture I and monomer mixture II may also contain other types of monomers. In some embodiments, the monomer mixture I and monomer mixture II each independently comprise one or more of vinyl aromatic compounds, alkyl (meth)acrylates, and ethylenically unsaturated carboxylic acid monomers. Herein, “independently” means that the selections can be the same or different, that is, the monomer mixture I contains one or more of vinyl aromatic compounds, alkyl (meth)acrylates, ethylenically unsaturated carboxylic acid monomers, and the monomer mixture II contains one or more of vinyl aromatic compounds, alkyl (meth)acrylates, ethylenically unsaturated carboxylic acid monomers, and monomer mixture I and monomer mixture II may be the same or may also be different.

Examples of vinyl aromatic compounds include one or more of styrene, α-methylstyrene, 2-chlorostyrene, 3-tert-butylstyrene, and 3,4-dimethylstyrene. In some embodiments, the monomer mixture I comprises 5-30% by weight, preferably 10-25% by weight, of vinyl aromatic compounds, relative to the total weight of the monomer mixture I. For example, the monomer mixture I comprises 15%, 18% or 20% by weight of vinyl aromatic compounds. In some embodiments, the monomer mixture II comprises 5-30% by weight, preferably 10-25% by weight, of vinyl aromatic compounds, relative to the total weight of monomer mixture II. For example, the monomer mixture I comprises 15%, 18% or 20% by weight of vinyl aromatic compounds.

The alkyl group in the alkyl (meth)acrylate may have 1-15 carbon atoms, for example 1-6 carbon atoms. In some embodiments, the alkyl (meth)acrylate is one or more of methyl (meth)acrylate, ethyl (meth)acrylate, propyl (meth)acrylate, n-butyl (meth)acrylate, isobutyl (meth)acrylate, pentyl (meth)acrylate, hexyl (meth)acrylate, n-octyl (meth)acrylate, isooctyl (meth)acrylate, and isobornyl (meth)acrylate. In some embodiments, the monomer mixture I comprises 50-85% by weight, preferably 60-75% by weight, of alkyl (meth)acrylates, relative to the total weight of the monomer mixture I. For example, the monomer mixture I comprises 55%, 60%, 70% or 80% by weight of alkyl (meth)acrylates. In some embodiments, the monomer mixture II comprises 5-40% by weight, preferably 10-30% by weight, of alkyl (meth)acrylates, relative to the total weight of monomer mixture II. For example, the monomer mixture II comprises 15%, 20% or 25% by weight of alkyl (meth)acrylates.

The alkyl group in the ethylenically unsaturated carboxylic acid monomer may have 1-15 carbon atoms, for example 1-6 carbon atoms. In some embodiments, the ethylenically unsaturated carboxylic acid monomer is one or more of (meth)acrylic acid, fumaric acid, itaconic acid, maleic acid, maleic anhydride, and itaconic anhydride. In some embodiments, the monomer mixture I comprises 0.1-5% by weight, preferably 0.5-3% by weight, of ethylenically unsaturated carboxylic acid monomers, relative to the total weight of the monomer mixture I. For example, the monomer mixture I comprises 0.8%, 1%, 1.5%, or 2% by weight of ethylenically unsaturated carboxylic acid monomers. In some embodiments, the monomer mixture II comprises 0.1-8% by weight, preferably 0.5-5% by weight, of ethylenically unsaturated carboxylic acid monomers, relative to the total weight of monomer mixture II. For example, monomer mixture II comprises 1%, 1.5%, 2%, 2.5%, 3%, or 3.5% by weight of ethylenically unsaturated carboxylic acid monomers.

In the waterborne emulsion as described herein, the polymer particles have lower hydroxyl value. In some embodiments, the polymer particles have a hydroxyl number in the range of 15 to 60 mg KOH/g resin. For example, the polymer particles may have a hydroxyl number of about 20, 25, 30, 40 or 50 mg KOH/g resin. The hydroxyl number is determined by titration according to ISO 4629-1998.

In some embodiments, the polymer particles have an average particle size of from 50 to 160 nm. For example, the average particle size of the polymer particles may be about 60 nm, 80 nm, 100 nm, 120 nm, or 140 nm.

### Preparation of Waterborne Emulsion

In the second aspect of the present application, a method for preparation of a waterborne emulsion for wood substrate is provided. The method includes:
1) pre-emulsification step to obtain a pre-emulsion I and a pre-emulsion II,
wherein the pre-emulsion I is prepared by mixing at least one emulsifier with water, and then adding monomer mixture I; and
wherein the pre-emulsion II is prepared by mixing at least one emulsifier with water, and then adding monomer mixture II; and
2) polymerization by: i) mixing the pre-emulsion I and at least one initiator to carry out polymerization reaction; and ii) adding the pre-emulsion II to the pre-emulsion I and at least one initiator to carry out polymerization reaction;
wherein the monomer mixture I and the monomer mixture II each independently contain at least one acrylic monomer with at least one hydroxyl group and at least one functional monomer with two or more double bonds, and weight ratio of the at least one acrylic monomer with at least one hydroxyl group in the monomer mixture I to the at least one acrylic monomer with at least one hydroxyl group in the monomer mixture II is in a range of from 1:30 to 2:1, and the waterborne emulsion for wood substrate comprises polymer particles having core-shell structure and having a hydroxyl content of from 0.2% to 2.2% by weight.

Emulsion polymerization techniques for preparing a waterborne emulsion from ethylenically unsaturated monomers are well known in the polymer art, and any conventional emulsion polymerization process may be used, such as single-stage polymerization process, multi-stage polymerization process, continuous process, and the like. It is well known that waterborne emulsion may be prepared using a seed polymerization process in order to control the structure and composition of the polymer particles contained in the waterborne emulsion.

In an exemplary embodiment of the present application, the waterborne emulsion is prepared as follows: a) under the action of a suitable emulsifier, the monomer mixture used to form the polymer core is dispersed in water to form an emulsion, and then the prepared emulsion is added in droplets into a polymerization reactor containing an initiator to carry out the polymerization, thereby forming a seed emulsion as a polymer core; b) then, in the presence of the above seed emulsion and optionally a suitable emulsifier, another monomer mixture used to form the polymer shell is further emulsion polymerized to form polymer particles with a core-shell structure.

Dispersion of the above polymerizable monomers can be accomplished with the aid of any suitable emulsifier. In some embodiments, at least one emulsifier is one or more of anionic emulsifier and non-ionic emulsifier. Some surfactants suitable for emulsion polymerization are disclosed, for example, in Mccutcheon's Detergents and Emulsifiers (MC Publishing Co., Glen Rock, NJ). Other types of stabilizing agents, such as protective colloids, may also be used. Preferably, a combination of anionic and non-ionic surfactants is used. Anionic surfactants may include one or more of aliphatic carboxylates, aliphatic sulfonates, aliphatic sulfates and aliphatic phosphates. Preferably, alkali metal (such as Na, K or Li) salts, or alkaline earth metal (such as Ca or Ba) salts are used. In a specific embodiment, an aliphatic sulfonate, preferably an alkali metal dodecylsulfonate, and more preferably sodium dodecylsulfonate (SDS) is used. Non-ionic surfactants may include one or more of alkylphenol polyoxyethylene ethers and fatty alcohol polyoxyethylene ethers. Preferably, alkylphenol polyoxyethylene ethers are used. In a specific embodiment, octylphenol ethoxylate (OP-10) is used.

Polymerization can be initiated using any known free radical initiator. Examples of usable initiators include those that thermally decompose at the polymerization temperature to generate radicals. Examples include water soluble and water insoluble initiators. Examples of free radical-generating initiators include persulfates such as ammonium persulfate or alkali metal persulfates (including potassium, sodium or lithium); peroxides such as cumene hydroperoxide, t-butyl hydroperoxide, di-tert-butyl peroxide, dioctyl peroxide, tert-butyl pervalerate, tert-butyl perisononanoate, tert-butyl peroctoate, tert-butyl perneodecanoate, peroxy bis(2-ethylhexyl)dicarbonate, bis(isotridecyl)peroxydicarbonate; azo compounds such as azobis(isobutyronitrile) and azobis(4-cyanovaleric acid); and conventional redox systems. Preferably, persulfates as the water soluble initiator are used. More specifically, ammonium persulfate is used as a radical initiator.

In some embodiments, the at least one initiator is one or more of potassium persulfate, sodium persulfate, ammonium persulfate, potassium persulfate-sodium bisulfite, sodium persulfate-sodium bisulfite, ammonium persulfate-sodium bisulfite and tert-butyl hydrogen peroxide-formaldehyde sodium bisulfite.

In the preparation of the waterborne latex of the present application, the amount of emulsifier and the amount of initiator and reaction conditions such as reaction temperature, stirring speed, etc. can be determined empirically by those skilled in the art. Preferably, the pre-emulsification process of monomer mixture is carried out at a stirring speed of 2000 rpm or higher, preferably at a stirring speed of 4000 rpm or higher.

What is described in the context of waterborne emulsion also applies to the preparation of waterborne emulsion, unless expressly indicated otherwise.

### Coating Composition

In the third aspect of the present application, a waterborne coating composition is provided, characterized in that the coating composition comprising: A) the waterborne emulsion for wood substrate, and B) at least one curing agent.

In some embodiments, at least one curing agent contains polyisocyanate. The polyisocyanate crosslinking agent contains two or more isocyanate functional groups, which can undergo chain extension and crosslinking reactions with the film-forming resin composition, thereby forming a three-dimensional network structure in the coating.

In some embodiments, the polyisocyanate is one or more of an aliphatic polyisocyanate, an alicyclic polyisocyanate, and an aromatic polyisocyanate.

Examples of polyisocyanate crosslinking agents are (blocked or unblocked) aliphatic polyisocyanates, cycloaliphatic or aromatic divalent, trivalent or polyvalent isocyanates, such as hexamethylene diisocyanate, cyclohexyl 1,4-diisocyanates and the like. Other non-limiting examples of generally suitable blocked polyisocyanates include isophorone diisocyanate, dicyclohexylmethane diisocyanate, toluene diisocyanate, diphenylmethane diisocyanate, phenylene diisocyanate, tetramethylxylene diisocyanate, xylylene diisocyanate, and mixtures and isomers thereof.

Preferred polyisocyanate crosslinking agents are unblocked or blocked polyisocyanates, more preferably blocked polyisocyanates, even more preferably polymeric blocked polyisocyanates.

In certain embodiments, polymeric blocked polyisocyanates may be used. Some examples of suitable polymeric blocked polyisocyanates include biurets or isocyanurates of diisocyanates, trifunctional “trimers”, or mixtures thereof. Examples of suitable trimers may include trimerization products made from an average of three diisocyanate molecules, or trimers produced by the reaction of an average of three moles of a diisocyanate (e.g. HDMI) with one mole of another compound such as a triol (e.g. trimethylol propane).

As an example of a polyisocyanate crosslinking agent, any suitable commercially available product may be used, such as a polymeric blocked polyisocyanate based on hexamethylene diisocyanate (HDI) trimer).

Component A may also be referred to as film-forming resin composition. In this application, components A and B are selected such that the molar ratio of hydroxyl groups (OH) to isocyanate groups (NCO) in the resulting system may vary in the range of from 1:1 to 1:2.5. In general, when the molar ratio of hydroxyl groups (OH) to isocyanate groups (NCO) is less than 1:2.5, the handling properties of the resulting two-component coating composition and/or the mechanical properties of the resulting coating may be deteriorated. When the molar ratio of hydroxyl groups (OH) to isocyanate groups (NCO) is greater than 1:1, the curing performance of the resulting coatings is poor. In some embodiments, the weight ratio of component A to component B is from 1:2 to 10:1, more preferably from 1:1 to 6:1, such as 2:1, 3:1, 4:1 or 5:1. Depending on actual needs, additional inert diluents that do not affect the reactivity of the film-forming resin and polyisocyanate crosslinking agent may be added during the preparation of the film-forming resin and/or polyisocyanate crosslinking agent, in order to for example reduce the viscosity of components. Therefore, the amounts of the film-forming resin and the polyisocyanate curing agent are not limited to the above-mentioned ranges, and may be adjusted according to actual needs.

In the two-component coating composition according to the application, component A may also comprise customary additives which do not adversely affect the two-component coating composition or the cured coating obtained therefrom. Suitable additives include, for example, those that will improve the processability or manufacturability of the composition, enhance the aesthetics of the composition, improve certain functional properties or characteristics (such as adhesion to the substrate) of the coating composition or cured composition derived therefrom, or those reagents that reduce costs. Additives that may be included are, for example, fillers, lubricants, coalescents (film-forming aids), wetting agents, plasticizers, defoamers, colorants, antioxidants, flow control agents, thixotropic agents, matting powders, dispersants, adhesion promoters agent, thickener, pH adjuster, solvent, curing catalyst or a combination thereof. Each of optional ingredients is present in an amount sufficient to serve its intended purpose, but preferably, such an amount does not adversely affect the two-component coating composition or the cured coating therefrom. In some preferred embodiments, component A may contain defoamers, coalescents, wetting agents, leveling agents, thickeners, matting powders or any combination thereof as conventional additives. According to the application, the total amount of customary additives is 0.1% to 25% by weight, for example about 20% by weight, relative to the total weight of component A. In some embodiments, the amount of coalescent maybe 2-8% by weight, the amount of defoamer may be 0.1-0.3% by weight, the amount of wetting agent may be 0.5-2% by weight, the amount of leveling agent may be 0.5-2% by weight, and alternatively, the amount of thickener may be 0.1-1% by weight.

According to the application, the two-component coating composition may be prepared by simply mixing the film-forming resin composition and the polyisocyanate crosslinking agent in a predetermined weight ratio in a mixing device before application. The resulting mixed coating composition may be applied using a variety of methods familiar to those skilled in the art, including spraying (e.g., air-assisted, airless, or electrostatic spraying), brushing, rolling, flooding, and dipping. In an embodiment of the application, the mixed coating composition is applied by spraying. The coating compositions may be applied in various wet film thicknesses. In embodiments of the present application, the wet film thickness preferably provides a dry film thickness of from about 13 to about 260 μm, and more preferably from about 75 to about 150 μm. Curing may be achieved by air drying the applied coating or by accelerating curing in various drying devices familiar to those skilled in the art, such as an oven.

### Article

The fourth aspect of the present application provides an article. The article as described herein comprises: a wood substrate having at least one major surface; and the waterborne emulsion for wood substrate as described herein applied on the at least one major surface of the wood substrate. After curing, a coating is formed from the waterborne emulsion or waterborne coating composition on at least one major surface of wood substrate.

In certain embodiments of the present application, the waterborne emulsion or waterborne coating composition of the present application may be used in conjunction with a primer. In this case, the article of the application comprises a substrate, a primer layer and a coating formed from the two-component coating composition of the application.

In some other embodiments of the present application, the two-component coating composition of the present application may be applied without a primer, but directly on the major surface of substrate.

The inventors have surprisingly found that coatings formed from the waterborne latex of the present application have particularly excellent chemical resistance, especially alcohol resistance and water resistance, compared to commercially available low-hydroxyl value acrylic emulsions. Moreover, compared with other self-crosslinking systems such as adding keto-hydrazine functional group compounds, organic silicon, etc., the coating formed by the waterborne latex of the present application still exhibits better alcohol resistance and water resistance, lower cost and higher stability of system.

### EXAMPLES

The disclosure in the present application will be described in further detail with reference to the following examples. However, it is to be understood that the following examples of the present application are only intended to be illustrative of the present application, and are not intended to limit the invention, because it would be obvious to those skilled in the art that various modifications and changes can be made within the scope of the disclosure of the present application. All parts, percentages, and ratios reported in the following examples are by weight unless otherwise stated. Moreover, all reagents used in the examples were commercially available and used without further treatment.

### Test Methods

Chemical resistance (liquid resistance): is measured according to the standard GB/T3324-2017 or GB/T4893.1-2005. The result is scored in a range of from 1 to 5, with 1 point representing the worst and 5 points representing the best.

Drying speed: According to the finger touch method in the Chinese national standard GB/T1728-2020 with the spraying amount being 600 g/m², the surface drying time of the paint film is measured.

### Example 1: Preparation of Waterborne Hydroxyacrylate Emulsion

The following procedure was used to prepare a waterborne hydroxyacrylate emulsion.

### 1) Pre-Emulsification

Under normal temperature and pressure, 0.75 parts of sodium lauryl sulfate and 32.5 parts of water were dissolved in an emulsification tank with stirring. Then a monomer mixture I of 42.5 parts of methyl methacrylate, 12.5 parts of styrene, 7.5 parts of isooctyl acrylate, 3.5 parts hydroxyethyl methacrylate, 2.5 parts of allyl methacrylate and 0.75 parts of carboxyl monomer (itaconic acid) was added followed by adding 0.3 parts of dodecanethiol under stirring, to give a pre-emulsion I.

Under normal temperature and pressure, 0.35 parts of sodium lauryl sulfate and 32.5 parts of water were dissolved in an emulsification tank with stirring. Then a monomer mixture II of 22.5 parts of isooctyl acrylate, 13 parts of hydroxyethyl methacrylate, 12.5 parts of methyl methacrylate, 12.5 parts of styrene, 1.75 parts of carboxyl monomer and 1 part of allyl methacrylate was added under stirring, to give a pre-emulsion II.

### 2) Polymerization

2 parts of sodium lauryl sulfate, 1.5 parts of sodium carbonate and 82.5 parts of water were added into the reaction kettle. The temperature was raised to 82.5° C. under stirring. After a blue light appeared, the pre-emulsion I and an initiator made of 0.3 parts of persulfate and 3 parts of water were added dropwise (in droplets). After the addition of pre-emulsion I, the mixture was kept warm for 30 min, and then the pre-emulsion II was added dropwise for 1 h at the dropping temperature of 82.5° C.

### 3) Work-Up

After the pre-emulsion II was added dropwise, the temperature was lowered to 62.5° C., and 0.2 parts of redox initiator was added dropwise. The mixture was kept warm for 35 min after the dropwise addition. Then, the temperature was lowered to 42.5° C., and 2 parts of ammonia water were added under stirring. Then the mixture was filtered.

The obtained waterborne hydroxyacrylate emulsion contained polymer particles having a core-shell structure and having a hydroxyl content of 1.6% and an average particle size of 120 nm.

The obtained acrylate emulsion was mixed with a coalescent, a defoamer, a wetting agent, a leveling agent, a thickener, matting powders and the like, to form component A. A mixture of 50 parts of polymeric blocked polyisocyanate and 50 parts of water was used as crosslinking agent component B. Component A and component B were mixed in a weight ratio of 100:25 to obtain a coating composition. Based on the total weight of the composition, the amounts of the coalescent, defoamer, wetting agent, leveling agent, thickener, and matting powders were 5% by weight, 0.2% by weight, 1.4% by weight, 1.4% by weight, 0.5% by weight and 2% by weight, respectively.

### Examples 2-3

In Example 2, Example 1 was repeated, except that the amount of an allyl methacrylate was 2.8% based on the total weight of pre-emulsion I and pre-emulsion II, and the resulting polymer particles had a hydroxyl content of 1%.

In Example 3, Example 1 was repeated, except that the amount of an allyl methacrylate was 3% based on the total weight of pre-emulsion I and pre-emulsion II, and the resulting polymer particles had a hydroxyl content of 0.8%.

### Comparative Example 1-3

In Comparative Example 1, a commercially available low-hydroxyl value acrylic emulsion (with a hydroxyl content of 1.6%) for wood substrate was used to replace the waterborne hydroxyacrylate emulsion in Example 1.

In Comparative Example 2, Example 1 was repeated, except that diacetone acrylamide (DAAM) was used instead of allyl methacrylate, and adipate dihydrazide (ADH) was added, wherein the weight ratio of DAAM to ADH was 2:1.

In Comparative Example 3, Example 1 was repeated, except that acetoacetoxyethyl methacrylate (AAEM) was used instead of allyl methacrylate.

In Comparative Example 4, Example 1 was repeated, except that the waterborne hydroxyacrylate emulsion in Example 1 was replaced by an acrylic emulsion with a hydroxyl content of 2.5%.

The coating compositions to be tested were sprayed onto a wood panel and then dried. The values of drying time were measured and reported. Performance of the dried coatings were tested. The results were shown in Table 1 below.

TABLE 1

| | drying | water | acid | alkali | alcohol | resistant to boiling |
|---|---|---|---|---|---|---|
| | speed/min | resistance | resistance | resistance | resistance | water (damp heat) |
| Example 1 | 30 | 4.5 | 5 | 5 | 4.8 | 4.5 |
| Example 2 | 28 | 4.4 | 5 | 5 | 5 | 4.4 |
| Example 3 | 25 | 4.3 | 5 | 5 | 5 | 4.3 |
| Comparative | 30 | 4.0 | 4 | 5 | 4.0 | 4.2 |
| Example 1 | | | | | | |
| Comparative | 30 | 4.1 | 4 | 5 | 4.2 | 4.1 |
| Example 2 | | | | | | |
| Comparative | 30 | 4.2 | 5 | 4 | 4.4 | 4.2 |
| Example 3 | | | | | | |
| Comparative | 60 | 4.3 | 5 | 5 | 5 | 4.3 |
| Example 4 | | | | | | |

The results in Table 1 show that the technical solution of the present application exhibits very excellent performance in terms of chemical resistance, while maintaining a satisfactory drying speed and an improved application performance. In particular, the technical solution of the present application exhibits excellent alcohol resistance. More surprisingly, the technical solution in the present application provides excellent comprehensive performance in terms of drying speed, water resistance, alcohol resistance, hot water resistance and the like.

### EMBODIMENTS

Embodiment 1: A waterborne emulsion for wood substrate comprising polymer particles having core-shell structure, characterized in that the core in the polymer particles is obtained by copolymerization of monomer mixture I, and the shell in the polymer particles is obtained by copolymerization of monomer mixture II, wherein the monomer mixture I and the monomer mixture II each independently contain at least one acrylic monomer with at least one hydroxyl group and at least one functional monomer with two or more double bonds, and weight ratio of the at least one acrylic monomer with at least one hydroxyl group in the monomer mixture I to weight of the at least one acrylic monomer with at least one hydroxyl group in the monomer mixture II is in a range of from 1:30 to 2:1, and the polymer particles having core-shell structure have a hydroxyl content of from 0.2% to 2.2% by weight.

Embodiment 2: An embodiment of Embodiment 1, characterized in that weight ratio of the monomer mixture I to the monomer mixture I is from 1:20 to 3.5:1.

Embodiment 3: An embodiment of Embodiment 1, characterized in that the monomer mixture I and the monomer mixture II each independently contain one or more of vinyl aromatic compound, alkyl (meth)acrylate, and ethylenically unsaturated carboxylic acid monomer.

Embodiment 4: An embodiment of Embodiment 3, characterized in that the vinyl aromatic compound is one or more of styrene, α-methylstyrene, 2-chlorostyrene, 3-tert-butyl styrene and 3,4-dimethylstyrene; or the alkyl (meth)acrylate is one or more of methyl (meth)acrylate, ethyl (meth)acrylate, propyl (meth)acrylate, n-butyl (meth)acrylate, isobutyl (meth)acrylate, amyl (meth)acrylate, hexyl (meth)acrylate, n-octyl (meth)acrylate, isooctyl (meth)acrylate, and isobornyl (meth)acrylate; or the ethylenically unsaturated carboxylic acid monomer is one or more of (meth)acrylic acid, fumaric acid, itaconic acid, maleic acid, maleic anhydride, and itaconic anhydride.

Embodiment 5: An embodiment of any of Embodiments 1 to 4, characterized in that the at least one acrylic monomer with at least one hydroxyl group is one or more of hydroxyethyl (meth)acrylate, hydroxypropyl (meth)acrylate, hydroxybutyl (meth)acrylate, hydroxyamyl (meth)acrylate and hydroxyhexyl (meth)acrylate.

Embodiment 6: An embodiment of any of Embodiments 1 to 4, characterized in that the at least one functional monomer with two or more double bonds is one or more of allyl methacrylate, allyl acrylate, ethylene glycol dimethacrylate, ethylene glycol diacrylate, 1,3-butanediol dimethacrylate, 1,3-butanediol diacrylate, 1,4-butanediol dimethacrylate, 1,4-butanediol diacrylate, 1,6-hexanediol dimethacrylate, 1,6-hexanediol diacrylate, diethylene glycol dimethacrylate, diethylene glycol diacrylate, triethylene glycol dimethacrylate, triethylene glycol diacrylate, dipropylene glycol dimethacrylate, dipropylene glycol diacrylate, tripropylene glycol dimethacrylate, tripropylene glycol diacrylate, trimethylolpropane trimethacrylate, trimethylolpropane triacrylate, pentaerythritol trimethacrylate, pentaerythritol triacrylate, pentaerythritol tetramethacrylate, pentaerythritol tetraacrylate and divinylbenzene.

Embodiment 7: An embodiment of any of Embodiments 1 to 4, characterized in that based on total weight of the monomer mixture I, the at least one acrylic monomer with at least one hydroxyl group in the monomer mixture I is present in an amount of from 1% to 10%; or based on total weight of the monomer mixture II, the at least one acrylic monomer with at least one hydroxyl group in the monomer mixture II is present in an amount of from 10% to 40%.

Embodiment 8: An embodiment of any of Embodiments 1 to 4, characterized in that based on total weight of the monomer mixture I, the at least one functional monomer with two or more double bonds in the monomer mixture I is present in an amount of from 0.05% to 5%; or based on total weight of the monomer mixture II, the at least one functional monomer with two or more double bonds in the monomer mixture II is present in an amount of from 0.5% to 10%.

Embodiment 9: An embodiment of any of Embodiments 1 to 4, characterized in that the polymer particles having core-shell structure have a hydroxyl acid of from 15 to 60 mg KOH/g resin.

Embodiment 10: An embodiment of any of Embodiments 1 to 4, characterized in that the polymer particles having core-shell structure have an average particle size of from 50 to 160 nm.

Embodiment 11: A method for preparation of a waterborne emulsion for wood substrate, characterized in that, the method comprising: 1) pre-emulsification step to obtain a pre-emulsion I and a pre-emulsion II, wherein the pre-emulsion I is prepared by mixing at least one emulsifier with water, and then adding monomer mixture I; and wherein the pre-emulsion II is prepared by mixing at least one emulsifier with water, and then adding monomer mixture II; and 2) polymerization by: i) mixing the pre-emulsion I and at least one initiator to carry out polymerization reaction; and ii) adding the pre-emulsion II to the pre-emulsion I and at least one initiator to carry out polymerization reaction; wherein the monomer mixture I and the monomer mixture II each independently contain at least one acrylic monomer with at least one hydroxyl group and at least one functional monomer with two or more double bonds, and weight ratio of the at least one acrylic monomer with at least one hydroxyl group in the monomer mixture I to weight of the at least one acrylic monomer with at least one hydroxyl group in the monomer mixture II is in a range of from 1:30 to 2:1, and the waterborne emulsion for wood substrate comprises polymer particles having core-shell structure having a hydroxyl content of from 0.2% to 2.2% by weight.

Embodiment 12: An embodiment of Embodiment 11, characterized in that, the at least one emulsifier is one or more anionic emulsifier and non-ionic emulsifier; or the at least one initiator is one or more of potassium persulfate, sodium persulfate, ammonium persulfate, potassium persulfate-sodium bisulfite, sodium persulfate-sodium bisulfite, ammonium persulfate-sodium bisulfite and tert-butyl hydrogen peroxide-formaldehyde sodium bisulfite.

Embodiment 13: A waterborne coating composition, characterized in that the coating composition comprising: a) the waterborne emulsion for wood substrate according to Embodiments 1-10, and b) at least one curing agent.

Embodiment 14: An embodiment of Embodiment 13, characterized in that the at least one curing agent contains polyisocyanate.

Embodiment 15: An embodiment of Embodiment 14, characterized in that the polyisocyanate is one or more of aliphatic polyisocyanate, alicyclic polyisocyanate and aromatic polyisocyanate.

Embodiment 16: A coated article, characterized in that the coated article comprising: a wood substrate having at least one major surface; and the waterborne emulsion for wood substrate according to any one of claims 1 to 10 or the waterborne coating composition according to any one of claims 13 to 15, applied on the at least one major surface of the wood substrate

While the invention has been described with reference to a number of embodiments and examples, those of ordinary skill in the art would recognize that other embodiments can be devised based on this disclosure. It will be readily apparent to those skilled in the art that changes may be made in the present application without departing from the principles disclosed in the foregoing specification. For example, without departing from the principles disclosed in the foregoing description, the technical solutions obtained by combining multiple features or preferred implementations described herein shall be understood to belong to the contents recorded herein. Such modifications are to be considered as included within the following claims unless the claims expressly state otherwise. Accordingly, the embodiments described in detail herein are illustrative only and do not intend to limit the scope of the invention which is to be given the full breadth of the appended claims and any and all equivalents thereof.

What is claimed is:

1. A waterborne emulsion for wood substrate comprising polymer particles having core-shell structure, characterized in that the core in the polymer particles is obtained by copolymerization of monomer mixture I, and the shell in the polymer particles is obtained by copolymerization of monomer mixture II, wherein the monomer mixture I and the monomer mixture II each independently contain at least one acrylic monomer with at least one hydroxyl group and at least one functional monomer with two or more double bonds, and weight ratio of the at least one acrylic monomer with at least one hydroxyl group in the monomer mixture I to weight of the at least one acrylic monomer with at least one hydroxyl group in the monomer mixture II is in a range of from 1:30 to 2:1, and the polymer particles having core-shell structure have a hydroxyl content of from 0.2% to 2.2% by weight.

2. The waterborne emulsion for wood substrate according to claim 1, characterized in that weight ratio of the monomer mixture I to the monomer mixture I is from 1:20 to 3.5:1.

3. The waterborne emulsion for wood substrate according to claim 1, characterized in that the monomer mixture I and the monomer mixture II each independently contain one or more of vinyl aromatic compound, alkyl (meth)acrylate, and ethylenically unsaturated carboxylic acid monomer.

4. The waterborne emulsion for wood substrate according to claim 3, characterized in that the vinyl aromatic compound is one or more of styrene, α-methylstyrene, 2-chlorostyrene, 3-tert-butyl styrene and 3,4-dimethylstyrene; or
the alkyl (meth)acrylate is one or more of methyl (meth)acrylate, ethyl (meth)acrylate, propyl (meth)acrylate, n-butyl (meth)acrylate, isobutyl (meth)acrylate, amyl (meth)acrylate, hexyl (meth)acrylate, n-octyl (meth)acrylate, isooctyl (meth)acrylate, and isobornyl (meth)acrylate; or
the ethylenically unsaturated carboxylic acid monomer is one or more of (meth)acrylic acid, fumaric acid, itaconic acid, maleic acid, maleic anhydride, and itaconic anhydride.

5. The waterborne emulsion for wood substrate according to claim 1, characterized in that the at least one acrylic monomer with at least one hydroxyl group is one or more of hydroxyethyl (meth)acrylate, hydroxypropyl (meth)acrylate, hydroxybutyl (meth)acrylate, hydroxyamyl (meth)acrylate and hydroxyhexyl (meth)acrylate.

6. The waterborne emulsion for wood substrate according to claim 1, characterized in that the at least one functional monomer with two or more double bonds is one or more of allyl methacrylate, allyl acrylate, ethylene glycol dimethacrylate, ethylene glycol diacrylate, 1,3-butanediol dimethacrylate, 1,3-butanediol diacrylate, 1,4-butanediol dimethacrylate, 1,4-butanediol diacrylate, 1,6-hexanediol dimethacrylate, 1,6-hexanediol diacrylate, diethylene glycol dimethacrylate, diethylene glycol diacrylate, triethylene glycol dimethacrylate, triethylene glycol diacrylate, dipropylene glycol dimethacrylate, dipropylene glycol diacrylate, tripropylene glycol dimethacrylate, tripropylene glycol diacrylate, trimethylolpropane trimethacrylate, trimethylolpropane triacrylate, pentaerythritol trimethacrylate, pentaerythritol triacrylate, pentaerythritol tetramethacrylate, pentaerythritol tetraacrylate and divinylbenzene.

7. The waterborne emulsion for wood substrate according to claim 1, characterized in that based on total weight of the monomer mixture I, the at least one acrylic monomer with at least one hydroxyl group in the monomer mixture I is present in an amount of from 1% to 10%; or
based on total weight of the monomer mixture II, the at least one acrylic monomer with at least one hydroxyl group in the monomer mixture II is present in an amount of from 10% to 40%.

8. The waterborne emulsion for wood substrate according to claim 1, characterized in that based on total weight of the monomer mixture I, the at least one functional monomer with two or more double bonds in the monomer mixture I is present in an amount of from 0.05% to 5%; or
based on total weight of the monomer mixture II, the at least one functional monomer with two or more double bonds in the monomer mixture II is present in an amount of from 0.5% to 10%.

9. The waterborne emulsion for wood substrate according to claim 1, characterized in that the polymer particles having core-shell structure have a hydroxyl acid of from 15 to 60 mg KOH/g resin.

10. The waterborne emulsion for wood substrate according to claim 1, characterized in that the polymer particles having core-shell structure have an average particle size of from 50 to 160 nm.

11. A method for preparation of a waterborne emulsion for wood substrate, characterized in that, the method comprising:
1) pre-emulsification step to obtain a pre-emulsion I and a pre-emulsion II,
wherein the pre-emulsion I is prepared by mixing at least one emulsifier with water, and then adding monomer mixture I; and
wherein the pre-emulsion II is prepared by mixing at least one emulsifier with water, and then adding monomer mixture II; and
2) polymerization by: i) mixing the pre-emulsion I and at least one initiator to carry out polymerization reaction; and ii) adding the pre-emulsion II to the pre-emulsion I and at least one initiator to carry out polymerization reaction;
wherein the monomer mixture I and the monomer mixture II each independently contain at least one acrylic monomer with at least one hydroxyl group and at least one functional monomer with two or more double bonds, and weight ratio of the at least one acrylic monomer with at least one hydroxyl group in the monomer mixture I to weight of the at least one acrylic monomer with at least one hydroxyl group in the monomer mixture II is in a range of from 1:30 to 2:1, and the waterborne emulsion for wood substrate comprises polymer particles having core-shell structure having a hydroxyl content of from 0.2% to 2.2% by weight.

12. The method according to claim 11, characterized in that, the at least one emulsifier is one or more anionic emulsifier and non-ionic emulsifier; or
the at least one initiator is one or more of potassium persulfate, sodium persulfate, ammonium persulfate, potassium persulfate-sodium bisulfite, sodium persulfate-sodium bisulfite, ammonium persulfate-sodium bisulfite and tert-butyl hydrogen peroxide-formaldehyde sodium bisulfite.

13. A waterborne coating composition, characterized in that the coating composition comprising:
a) the waterborne emulsion for wood substrate according to claim 1, and
b) at least one curing agent.

14. The waterborne coating composition according to claim 13, characterized in that the at least one curing agent contains polyisocyanate.

15. The waterborne coating composition according to claim 14, characterized in that the polyisocyanate is one or more of aliphatic polyisocyanate, alicyclic polyisocyanate and aromatic polyisocyanate.

16. A coated article, characterized in that the coated article comprising:
a wood substrate having at least one major surface; and
the waterborne emulsion for wood substrate according to claim 1 or the waterborne coating composition according to any one of claims 13 to 15, applied on the at least one major surface of the wood substrate.
